(19) United States
(12) Patent Application Publication
(10) Pub. No.: US 2017/0304936 A1
(43) Pub. Date: Oct. 26, 2017

(54) REMELTING AND SUBSEQUENT APPLICATION WELDING AND COMPONENT

(71) Applicant: Siemens Aktiengesellschaft, München (DE)

(72) Inventors: Bernd Burbaum, Falkensee (DE); Torsten Neddemeyer, Falkensee (DE)

(21) Appl. No.: 15/518,171

(22) PCT Filed: Oct. 12, 2015
(86) PCT No.: PCT/EP2015/073557

§ 371 Date: Apr. 10, 2017

(30) Foreign Application Priority Data
Oct. 31, 2014 (DE) 10 2014 222 266.4

(51) Int. Cl. B23K 26/00; B23K 26/342; B23K 26/60; F01D 5/28; B23P 6/00; B23K 103/18

(52) U.S. Cl. CPC B23K 26/0081; F01D 5/286; B23P 6/007; B23K 26/342; B23K 26/60; B23K 2203/26

(57) ABSTRACT

After remelting in a suitable mold for reducing grain boundaries, an oxidation-resistant material is epitaxially grown so that the oxidation resistance of a repaired material or also of a new part is improved.

### CROSS-REFERENCE TO RELATED APPLICATIONS

This application claims priority to PCT Application No. PCT/EP2015/073557, having a filing date of Oct. 12, 2015, based off of German application No. DE 102014222266.4 having a filing date of Oct. 31, 2014, the entire contents of both are hereby incorporated by reference.

### FIELD OF TECHNOLOGY

The following relates to finishing of surfaces by remelting and deposition welding, and to a component.

### BACKGROUND

Wear by erosion or corrosion arises during the repair of components, e.g. of turbine blades. In that context, it is necessary to close cracks and to deposit new material, while preserving the oxidation properties or oxidation protection. Certain materials are not resistant to oxidation.

As a result, re-use of the component is limited if there are increased requirements in terms of erosion or corrosion resistance.

### SUMMARY

An aspect relates to specifying a method with which this problem can be solved. A method and metallic component is disclosed for surface treatment of a metallic substrate, in which the surface of the metallic substrate first undergoes remelting in order to remove cracks and to reduce grain boundaries, followed by deposition welding of a more oxidation-resistant material at least partially onto the remelted region.

### DETAILED DESCRIPTION

The description shows merely an exemplary embodiment of the invention.

What is proposed is a method having two steps:

Step 1:
Processing a surface of a substrate by remelting. Remelting, in particular using a laser beam, can be used to create long grains along the remelted track, thus removing grain boundaries at the surface.
Step 2:
An oxidation-resistant layer, in particular consisting of NiCoCrAlY, can be deposition-welded onto the remelted zone by epitaxial deposition welding, in particular using a laser, such that this layer grows in particular epitaxially onto the substrate (identical crystallographic orientation as the base material) with few or no grain boundaries.
This improves the oxidation resistance at the surfaces of polycrystalline components made of nickel-based superalloys, in particular because by virtue of the epitaxy fewer grain boundaries are available for oxidation damage, and additionally because a coating provides additional oxidation protection.
The material of the oxidation-resistant layer is different from the material of the substrate of the metallic component. Different means that there is 15% more or less of at least one alloy element, or that at least one alloy element is or is not present.

1. A method for surface treatment of a metallic substrate, in which the surface of the metallic substrate first undergoes remelting in order to remove cracks and to reduce grain boundaries, followed by deposition welding of a more oxidation-resistant material at least partially onto the remelted region.

2. The method as claimed in claim 1, in which deposition welding of the oxidation-resistant material is conducted epitaxially.

3. The method as claimed in claim 1, in which the more oxidation-resistant material is a NiCoCrAlX alloy, X being in particular rhenium, silicon, yttrium, tantalum and/or iron.

4. The method as claimed in claim 1, in which the remelting and the deposition welding are carried out in the same device.

5. The method as claimed in claim 1, in which the substrate is a nickel-based or cobalt-based alloy.

6. The method as claimed in claim 1, in which the material of the oxidation-resistant material is different from the material of the substrate.

7. A metallic component, comprising: on a remelt region of a substrate of the component, a more oxidation-resistant material of an epitaxially grown material.

8. The component as claimed in claim 7, in which the substrate is a nickel-based or cobalt-based alloy.

9. The component as claimed in claim 1, in which the material of the oxidation-resistant material is different from the material of the substrate.

10. The component as claimed in claim 1, in which the more oxidation-resistant material is a NiCoCrAlX alloy, X being in particular rhenium, silicon, yttrium, tantalum and/or iron.
